(19) United States
(12) Patent Application Publication
(10) Pub. No.: US 2022/0300403 A1
(43) Pub. Date: Sep. 22, 2022

(54) ISOLATED SOFTWARE TESTING IN PRODUCTION VEHICLES

(71) Applicant: Ford Global Technologies, LLC, Dearborn, MI (US)

(72) Inventors: Paul Graff, Plymouth, MI (US); Nasser Shuaibi, Dearborn, MI (US); Jason Grix, Livonia, MI (US); Dona Burkard, Rochester Hills, MI (US)

(73) Assignee: Ford Global Technologies, LLC, Dearborn, MI (US)

(21) Appl. No.: 17/202,403

(22) Filed: Mar. 16, 2021

(51) Int. Cl. G06F 11/36

(52) U.S. Cl. CPC G06F 11/3688; G06F 11/3684; G06F 11/3692

(57) ABSTRACT

A first device comprises a multi-core processor and a memory storing instructions executable by the multi-core processor to initiate execution of operational control programming for the first device on one or more cores among a plurality of cores of the multi-core processor, initiate execution of test programming for the first device on a designated test core among the plurality of cores of the multi-core processor, wherein the designated test core is not one of the one or more cores, wherein the test programming generates test output data. and output the test output data to a second device.

### BACKGROUND

In many types of modern vehicles, numerous vehicle operations, features, and systems are implemented, managed, and/or controlled at least in part by programming, e.g., software) executing on computers and/or control units in those vehicles. Verifying the suitability of programming for operations, features, and/or systems to a desired degree of confidence may require high-confidence validation, which can involve in-vehicle testing of the programming over a large number of test drives and/or test miles.

### BRIEF DESCRIPTION OF THE DRAWINGS

FIG. 1 is a block diagram of a first example system.

FIG. 2 is a block diagram of an example server.

FIG. 3 is a block diagram of an example device.

FIG. 4 is a block diagram of a second example of the device.

FIG. 5 is a block diagram illustrating example operations that can be performed at the device.

FIG. 6 is a block diagram of a second example system.

FIG. 7 is a block diagram of an example process flow.

FIG. 8 is a block diagram of an example storage medium.

### DETAILED DESCRIPTION

Disclosed herein are techniques for isolated software testing in production vehicles that can be implemented in order to conduct high-confidence validation of vehicle software in a faster and less costly manner. According to such techniques, vehicle software that is in need of validation can be tested in production vehicles as they are operated by consumers. The software being tested can execute on separate processor cores from those running the production software that controls actual vehicle operations, features, and/or systems. Further, memory isolation can be established between the production software and the software being tested, to prevent the latter from writing to, or executing, any part of the production software. Establishing such processing and memory isolation can enable the software being tested to execute in parallel with the production software while preventing or minimizing impact on the performance of the vehicle.

Disclosed herein is a first device, comprising a multi-core processor and a memory storing instructions executable by the multi-core processor to initiate execution of operational control programming for the first device on one or more cores among a plurality of cores of the multi-core processor, initiate execution of test programming for the first device on a designated test core among the plurality of cores of the multi-core processor, wherein the designated test core is not one of the one or more cores, wherein the test programming generates test output data, and output the test output data to a second device.

The first device can comprise a memory protection unit to isolate a memory space of the operational control programming from a memory space of the test programming.

The operational control programming can include a first instance of an operating system (OS) running on the one or more cores, and the test programming can include a second instance of the OS running on the designated test core.

The operational control programming can copy test input data to a memory space of the test programming to provide the test programming with access to the test input data.

The operational control programming can trigger a data offload mechanism in response to a determination that the test output data is ready for offloading from the first device.

The test programming can partition the test output data into a plurality of data blocks and append headers to the plurality of data blocks.

The memory can store instructions executable by the multi-core processor to send the test output data, via a vehicle bus, to a gateway module.

The operational control programming can monitor a network connection for a disable signal from a testing back end.

The operational control programming can disable the designated test core in response to detecting the disable signal.

Further disclosed herein is a method, comprising initiating execution of operational control programming for a first device on one or more cores among a plurality of cores of a multi-core processor of the first device, initiating execution of test programming for the first device on a designated test core among the plurality of cores of the multi-core processor, wherein the designated test core is not one of the one or more cores, wherein the test programming generates test output data, and outputting the test output data to a second device.

The first device can include a memory protection unit to isolate a memory space of the operational control programming from a memory space of the test programming.

The operational control programming can include a first instance of an operating system (OS) running on the one or more cores, and the test programming can include a second instance of the OS running on the designated test core.

The operational control programming can copy test input data to a memory space of the test programming to provide the test programming with access to the test input data.

The operational control programming can trigger a data offload mechanism in response to a determination that the test output data is ready for offloading from the first device.

The test programming can partition the test output data into a plurality of data blocks and append headers to the plurality of data blocks.

The method can include sending the test output data, via a vehicle bus, to a gateway module.

The operational control programming can monitor a network connection for a disable signal from a testing back end.

The operational control programming can disable the designated test core in response to detecting the disable signal.

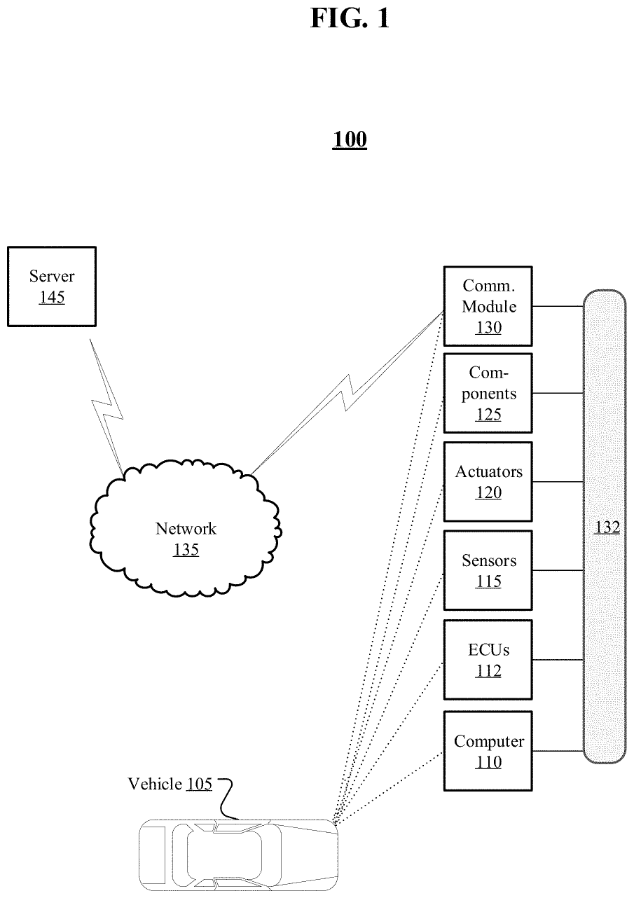

FIG. 1 is a block diagram of an example vehicle system 100. The system 100 includes a vehicle 105, which is a land vehicle such as a car, truck, etc. The vehicle 105 includes a computer 110, electronic control units (ECUs) 112, vehicle sensors 115, actuators 120 to actuate various vehicle components 125, a communications module 130, and a vehicle network 132. Communications module 130 allows vehicle 105 to communicate with a server 145 via a network 135.

The computer 110 includes a processor and a memory. The memory includes one or more forms of computer-readable media, and stores instructions executable by the computer 110 for performing various operations, including as disclosed herein.

The computer 110 may operate vehicle 105 in an autonomous, a semi-autonomous mode, or a non-autonomous (manual) mode, i.e., can control and/or monitor operation of the vehicle 105, including controlling and/or monitoring components 125. For purposes of this disclosure, an autonomous mode is defined as one in which each of vehicle propulsion, braking, and steering are controlled by the computer 110; in a semi-autonomous mode the computer 110 controls one or two of vehicle propulsion, braking, and steering; in a non-autonomous mode a human operator controls each of vehicle propulsion, braking, and steering.

The computer 110 may include programming to operate one or more of vehicle brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via vehicle network 132 as described further below, more than one processor, e.g., included in ECUs 112 or the like included in the vehicle 105 for monitoring and/or controlling various vehicle components 125, e.g., a powertrain controller, a brake controller, a steering controller, etc. Further, the computer 110 may communicate, via communications module 130, with a navigation system that uses the Global Position System (GPS). As an example, the computer 110 may request and receive location data of the vehicle 105. The location data may be in a conventional format, e.g., geo-coordinates (latitudinal and longitudinal coordinates).

Vehicle network 132 is a network via which messages can be exchanged between various devices in vehicle 105. Computer 110 can be generally programmed to send and/or receive, via vehicle network 132, messages to and/or from other devices in vehicle 105 (e.g., any or all of ECUs 112, sensors 115, actuators 120, components 125, communications module 130, a human machine interface (HMI), etc.). Additionally or alternatively, messages can be exchanged among various such other devices in vehicle 105 via vehicle network 132. In cases in which computer 110 actually comprises a plurality of devices, vehicle network 132 may be used for communications between devices represented as computer 110 in this disclosure. Further, as mentioned below, various controllers and/or vehicle sensors 115 may provide data to the computer 110.

In some implementations, vehicle network 132 can be a network in which messages are conveyed via a vehicle communications bus. For example, vehicle network can be a controller area network (CAN) in which messages are conveyed via a CAN bus, or a local interconnect network (LIN) in which messages are conveyed via a LIN bus.

In some implementations, vehicle network 132 can be a network in which messages are conveyed using other wired communication technologies and/or wireless communication technologies (e.g., Ethernet, WiFi, Bluetooth, etc.). Additional examples of protocols that may be used for communications over vehicle network 132 in some implementations include, without limitation, Media Oriented System Transport (MOST), Time-Triggered Protocol (TTP), and FlexRay.

In some implementations, vehicle network 132 can represent a combination of multiple networks, possibly of different types, that support communications among devices in vehicle 105. For example, vehicle network 132 can include a CAN in which some devices in vehicle 105 communicate via a CAN bus, and a wired or wireless local area network in which some device in vehicle 105 communicate according to Ethernet or Wi-Fi communication protocols.

Vehicle sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles), etc., relative to the location of the vehicle 105. The vehicle sensors 115 may further include camera sensor(s) 115, e.g., front view, side view, rear view, etc., providing images from a field of view inside and/or outside the vehicle 105.

Actuators 120 are implemented via circuitry, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via communication module 130 with devices outside of the vehicle 105, e.g., through vehicle-to-vehicle (V2V) or vehicle-to-infrastructure (V2X) wireless communications to another vehicle, to (typically via the network 135) a remote server 145. The communications module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth®, IEEE 802.11, dedicated short range communications (DSRC), and/or wide area networks (WAN), including the Internet, providing data communication services.

The network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC) and cellular V2V (CV2V), cellular V2X (CV2X), etc.), local area networks (LAN) and/or wide area networks (WAN), including the Internet, providing data communication services.

Computer 110 can receive and analyze data from sensors 115 substantially continuously, periodically, and/or when instructed by a server 145, etc. Further, object classification or identification techniques can be used, e.g., in a computer 110 based on lidar sensor 115, camera sensor 115, etc., data, to identify a type of object, e.g., vehicle, person, rock, pothole, bicycle, motorcycle, etc., as well as physical features of objects.

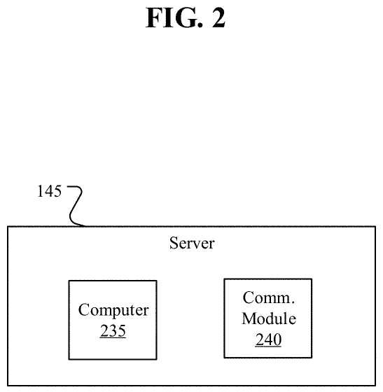

FIG. 2 is a block diagram of an example server 145. The server 145 includes a computer 235 and a communications module 240. The computer 235 includes a processor and a memory. The memory includes one or more forms of computer-readable media, and stores instructions executable by the computer 235 for performing various operations, including as disclosed herein. The communications module 240 allows the computer 235 to communicate with other devices, such as the vehicle 105.

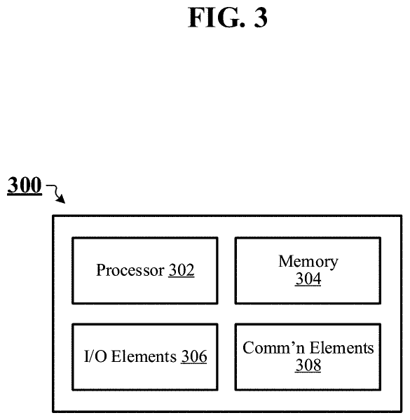

FIG. 3 is a block diagram of an example device 300. According to some implementations, device 300 may be representative of a device, component, or element(s) comprised in vehicle 105 of FIG. 1. For example, according to various implementations, device 300 can be representative of computer 110, or an ECU 112. As shown in FIG. 3, device 300 can include a processor 302, a memory 304, input/output (I/O) elements 306, and communication elements 308.

In some implementations, processor 302 can be a general-purpose processor. In some implementations, device 300 can be (or include) a microcontroller, and processor 302 can represent processing circuitry of that microcontroller. In some implementations, processor 302 can be (or include) a dedicated electronic circuit including an ASIC that is manufactured for a particular operation, e.g., an ASIC for processing sensor data and/or communicating the sensor data. In another example, processor 302 can be (or include) an FPGA (Field-Programmable Gate Array) which is an integrated circuit manufactured to be configurable by an occupant. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in processor 302.

Memory 304 can include one or more forms of computer-readable media, and can store instructions executable by processor 302 for performing various operations, including as disclosed herein.

I/O elements 306 are suitable elements to receive input signals from — and/or send output signals to — other device(s), component(s), or element(s) coupled with device 300. In an example, device 300 can be a powertrain or engine control module, and can include an I/O element 306 comprising an input port to receive an accelerator input signal from an accelerator pedal module and another I/O element 306 comprising an output port to send a throttle control signal to a throttle control module. In another example, device 300 can be a brake control module, and can include an I/O element 306 comprising an input port to receive a brake input signal from a brake pedal module and another I/O element 306 comprising an output port to send an actuation signal to a hydraulic brake valve.

Communication elements 308 are elements operable to send and/or receive communications over one or more communication links in accordance with one or more associated communication protocols. In an example, device 300 can include a communication element 308 comprising a vehicle bus transceiver operable to communicate over a vehicle bus of vehicle network 132 of FIG. 1.

During operation of a vehicle (e.g., vehicle 105) containing device 300, operational control programming, e.g., software, executing on processor 302 may implement, manage, and/or control one or more operations, features, and/or systems of the vehicle. If device 300 is used in production vehicles, high-confidence validation may be specified in order to verify the suitability of that programming to a desired degree of confidence. This may include testing the programming on device 300 over a large number of test drives and/or test miles.

According to one approach, high-confidence validation could be completed on a closed course, by testing the programming using appropriate hardware of a test vehicle. However, the large numbers of operational cycles and/or test miles that may be required for high-confidence validation may render this a slow and costly process. According to an approach described herein, programming (e.g., software) that is under consideration for prospective use as operational control programming impacting the actual performance/behavior of production vehicles can be tested in production vehicles as they are operated by consumers. Such programming can execute in parallel with the operational control programming. Isolation can be established between the two, so that the test programming being validated cannot interfere with the operational control programming or the actual performance/behavior of the vehicle.

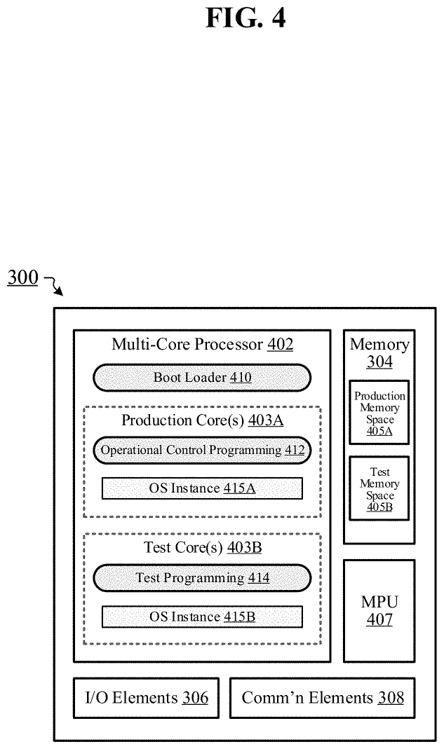

FIG. 4 illustrates an example implementation of device 300, according to which device 300 may be used for isolated software testing in production vehicles. In FIG. 4, a multi-core processor 402 is used to implement processor 302 of FIG. 3. Multi-core processor 402 can execute programming including a boot loader 410, operational control programming 412, and test programming 414. The term “multi-core processor” as used herein refers to a processor that features two or more separate processing units (“cores”) on which instructions can be executed concurrently.

Boot loader 410 is programming that performs operations to initialize various components of device 300 (e.g., upon startup) to make them operational and available for use by operational control programming 412. In some implementations, boot loader 410 can be implemented in software. In some implementations, boot loader 410 can additionally or alternatively be implemented in firmware and/or hardware logic.

One or more cores (production core(s) 403A) of multi-core processor 402 are used to execute operational control programming 412. Operational control programming 412 is programming, e.g., software, that performs operations impacting the actual performance/behavior of a vehicle containing device 300 (and/or device 300 itself) as that vehicle is operated. In some implementations, operational control programming 412 can be implemented in software. In some implementations, operational control programming 412 can additionally or alternatively be implemented in firmware and/or hardware logic.

One or more other cores (test core(s) 403B) of multi-core processor 402 are used to execute test programming 414. In some implementations, test programming 414 can be programming implemented in software. In some implementations, test programming 414 can additionally or alternatively include programming implemented in firmware and/or hardware logic.

In some implementations, test programming 414 can be programming that is being considered/evaluated for prospective inclusion in a future update to operational control programming 412, or programming that is being considered for use as a replacement for operational control programming 412.

In some implementations, test programming 414 can be programming that is under consideration for prospective use in a device other than device 300 (e.g., as a prospective update to/replacement for operational control programming of another device).

In some implementations, test programming 414 can be programming that implements algorithm(s), process(es), and/or parameter(s) that are to refined/optimized for inclusion in operational control programming 412 (and/or operational control programming of device(s) other than device 300). For example, test programming 414 can be programming that implements an algorithm for anticipating manual pedal inputs (i.e., on the part of the driver) while a cruise control feature is controlling vehicle speed.

In some implementations, device 300 can be configured/provisioned with test programming 414 during production/manufacturing of device 300 or production/manufacturing of a vehicle (e.g., vehicle 105) that contains device 300. In some implementations, device 300 can be configured/provisioned with test programming 414 (and/or test programming 414 can be modified or updated) in conjunction with vehicle servicing (e.g., at a dealer's service department) after the vehicle has been sold to a consumer. In some implementations, device 300 can be configured/provisioned with test programming 414 (and/or test programming 414 can be modified or updated) wirelessly, such as via over-the-air updates.

On startup/power up of device 300, multi-core processor 402 can execute boot loader 410, which can perform a startup procedure in order to bring device 300 “on-line” and ready to begin normal operations (i.e., begin executing operational control programming 412). As part of the startup procedure, boot loader 410 can designate one or more cores of multi-core processor 402 to serve as production core(s) 403A, and can designate one or more other cores of multi-core processor 402 to serve as test core(s) 403B (such that production core(s) 403A and test core(s) 403B include no common cores). In some implementations, boot loader 410 may not be permitted to designate a core executing boot loader 410 as a core that is to serve as a production core 403A or test core 403B. In other implementations, boot loader 410 may not be permitted to designate a core executing boot loader 410 as a test core 403B, but may be permitted to designate that core as a production core 403A. In yet other implementations, boot loader 410 may be permitted to designate any core of multi-core processor 402 as a production core 403A or a test core 403B.

Further in conjunction with the startup procedure, boot loader 410 can perform operations to initiate execution of operational control programming 412 on production core(s) 403A. For example, in some implementations, boot loader 410 can schedule a production application start task for handling by one or more of production core(s) 403A, and operational control programming 412 may begin running on production core(s) 403A in conjunction with execution of that task.

In some implementations, in conjunction with the startup procedure, boot loader 410 can perform operations to initiate execution of test programming 414 on test core(s) 403B. For example, in some implementations, boot loader 410 can schedule a test application start task for handling by one or more of test core(s) 403B, and test programming 414 may begin running on test core(s) 403B in conjunction with execution of that task. In some implementations, execution of test programming 414 may not be initiated in conjunction with startup, but rather at a subsequent point during ongoing operation of device 300. In some implementations, for example, execution of test programming 414 may be initiated upon the detection of a triggering event/condition (e.g., detecting that a particular vehicle feature has been activated), or once a certain amount of time has elapsed relative to a reference time (e.g., the time of startup/power of device 300). In some implementations, execution of test programming 414 may be initiated in response to receipt, at device 300, of a triggering message or command sent by a remote server (e.g., server 145) via network 135.

In some implementations, device 300 may be configured to provide isolation of memory between operational control programming 412 and test programming 414. For example, as shown in FIG. 4, device 300 can include a memory protection unit (MPU) 407, which can be used to establish memory isolation between operational control programming 412 and test programming 414. This can involve isolating a production memory space 405A used by production core(s) 403A from a test memory space 405B used by test core(s) 403B. Establishing such memory isolation can preemptively thwart potential attempts on the part of test programming 414 to write or execute to any parts of operational control programming 412.

In some implementations, the memory isolation can enforce an asymmetrical access scheme, such that production core(s) 403A's access/rights with respect to test memory space 405B are not constrained in the manner in which test core(s) 403B's access/rights are constrained with respect to production memory space 405A. For example, production core(s) 403A can be provided with read and write access to test memory space 405B, while test core(s) 403B can be provided only with read access to production memory space 405A, and barred from writing to production memory space 405A. In some implementations, similar asymmetrical access can be established with respect to one or more I/O elements 306 and/or communication elements 308.

In some implementations, an operating system (OS) instance 415A may run on one or more of production core(s) 403A. OS instance 415A can include a scheduler for scheduling tasks to be performed by production core(s) 403A, and can handle exceptions generated in conjunction with execution of operational control programming 412 on production core(s) 403A. In some implementations, as shown in FIG. 4, a separate OS instance 415B can run on test core(s) 403B. Running this separate OS instance 415B on test core(s) 403B can provide a separate scheduler for scheduling tasks to be performed by test core(s) 403B, and provide the ability to handle exceptions generated in conjunction with execution of test programming 414 on test core(s) 403B without interfering with execution of operational control programming 412 on production core(s) 403A.

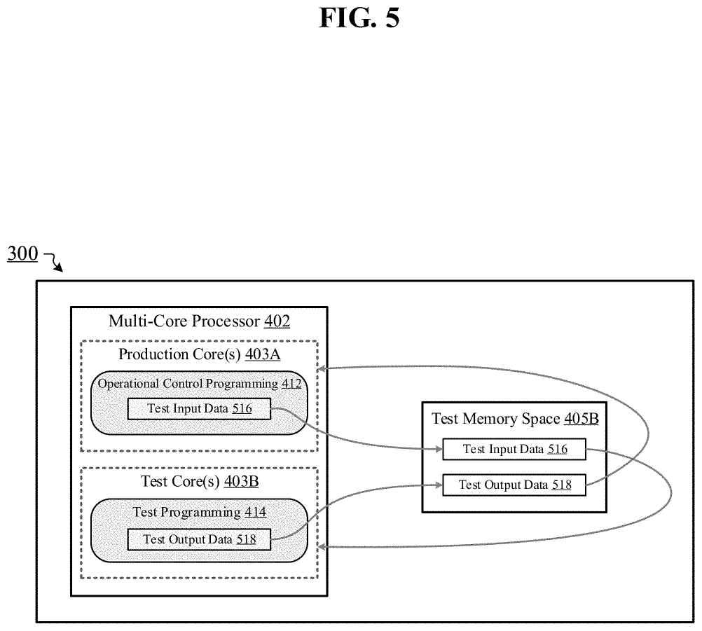

FIG. 5 illustrates example operations that can be performed at device 300 during isolated software testing in production vehicles according to various implementations. During isolated software testing, test programming 414 may require access to test input data 516 in order to conduct various types of testing operations/computations. Test input data 516 may generally represent data indicating actual operating parameters of a vehicle (e.g., vehicle 105) containing device 300, other devices, components, or elements contained in device 300, and/or device 300 itself. Operational control programming 412 can identify/compose test input data 516 of various types based on signals and/or communications that device 300 receives from other devices, components, or elements contained in the vehicle.

Once operational control programming 412 has identified/composed test input data 516 required by test programming 414, operational control programming 412 may need to establish a way for test programming 414 to access that test input data 516. According to one approach, in order to provide test programming 414 with access to test input data 516, operational control programming 412 can activate a task for performance by test core(s) 403B to cause test programming 414 to read that test input data 516 from location(s) within production memory space 405A of FIG. 4. However, in some implementations, as exemplified in FIG. 5, operational control programming 412 can be configured to instead copy test input data 516 into test memory space 405B. Operational control programming 412 can then activate a task for performance by test core(s) 403B to cause test programming 414 to read test input data 516 from location(s) within test memory space 405B. In some implementations, the latter approach can help prevent race conditions between production core(s) 403A and test core(s) 403B, and can obviate need for the use of memory locks.

Test programming 414 can generate test output data 518 describing results of tests that it performs based on test input data 516, and can store that test output data 518 in test memory space 405B. Device 300 can use a data offload mechanism to convey test output data 518 from device 300 to a testing back end. In order to isolate test programming 414 from operational control programming 412, operational control programming 412 can be provided with ownership of the data offload mechanism. Operational control programming 412 can monitor for the existence of test output data 518 that is ready to be sent off of device 300, and upon identifying test output data 518 that is ready to be sent, can trigger the data offload mechanism.

When operational control programming 412 triggers the data offload mechanism, test output data 518 may need to be conveyed from device 300 to a communication module capable of communicating over links external to the vehicle. In some implementations, test output data 518 can be sent to such a communication module (e.g., communication module 130 of FIG. 1) via vehicle network 132. In some cases, test output data 518 may constitute an amount of data too large to fit in a single message sent over vehicle network 132. In an example, vehicle network 132 may be a CAN bus, and an applicable size limit for messages sent over the CAN bus may preclude sending test output data 518 in a single message. In some implementations, test core(s) 403B/test programming 414 can be configured to partition test output data 518 into multiple blocks of suitable size, for transmission over vehicle network 132 in multiple respective messages. In some such implementations, test core(s) 403B/test programming 414 can be configured to add headers to the messages in order to provide information enabling a receiving entity to correctly reassemble the multiple blocks and thus obtain test output data 518.

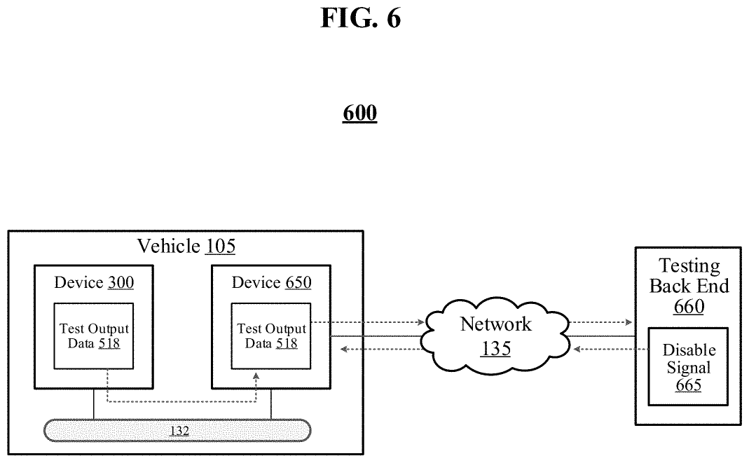

FIG. 6 is a block diagram of an example system 600 for isolated software testing in production vehicles according to various implementations. In system 600, vehicle 105 includes device 300 and a device 650. Device 300 can output test output data 518 to device 650 via vehicle network 132, for subsequent delivery to a testing back end 660 via network 135.

According to some implementations, upon triggering of the data offload mechanism as discussed above, test output data 518 can be sent directly to communication module 130 for transmission off of vehicle 105. In the context of such implementations, device 650 can thus represent communication module 130.

In some implementations, transmission of test output data 518 off of vehicle 105 may be deferred until some future event or point in time following triggering of the data offload mechanism. For example, if Wi-Fi connectivity is unavailable when the data offload mechanism is triggered, and test output data 518 of a large size that makes the use of an available cellular data connection undesirable, transmission of test output data 518 may be deferred pending the establishment of Wi-Fi connectivity. In another example, transmission of test output data 518 off of vehicle 105 can be deferred pending receipt of a triggering message via network 135.

With respect to some implementations in which transmission of test output data 518 off of vehicle 105 is deferred, device 650 can be an intermediary device that receives and stores test output data 518, and then delivers it to communication module 130 for transmission upon the future event or point in time. In the aforementioned example in which test output data 518 is large and transmission off of vehicle 105 is deferred pending the establishment of Wi-Fi connectivity, device 650 can be a device capable of storing large amounts of data. For example, device 650 can be a gateway module, which can receive and accumulate/store data from various devices, such as ECUs 112, via a vehicle bus or vehicle network, such as vehicle network 132. Such a gateway module can make such accumulated/stored data available for access by devices, nodes, services, and/or entities external to vehicle 105 via a communication network such as network 135.

In some implementations, device 300 can partition test output data 518 into a plurality of blocks for transmission over vehicle network 132. In some implementations, device 650 can receive test output data 518 in the form of a plurality of messages, each including a header and a respective one of the plurality of blocks. In some implementations, vehicle 105 can send test output data 518 to testing back end 660 (via network 135) in partitioned form, along with the header information necessary to reassemble the blocks to obtain test output data 518. In such implementations, reassembly of test output data 518 can be performed at testing back end 660. In other implementations, device 650 can be configured to reassemble test output data 518 itself, using information comprised in the headers of the messages received from device 300 via vehicle network 132.

In some implementations, the test programming 414 on device 300 can be designed to enable test programming 414 to be disabled remotely. For example, a user of vehicle 105 may have the option of opting out of test data collection by setting a preference on a website, and if the user does so, test programming 414 may be disabled. In some implementations, responsive to a determination to disable test programming 414 (e.g., based on a user opt-out), testing back end 660 may send a disable signal 665 to vehicle 105. On device 300, production core(s) 403A may be configured to listen for such a disable signal. When disable signal 665 arrives at vehicle 105, it may be routed to device 300 (e.g., via device 650 and vehicle network 135), where it may be detected by production core(s) 403A (e.g., by operational control programming 412 executing on production core(s) 403A). Upon detection of disable signal 665, test core(s) 403B may be disabled, and execution of test programming 414 may terminate.

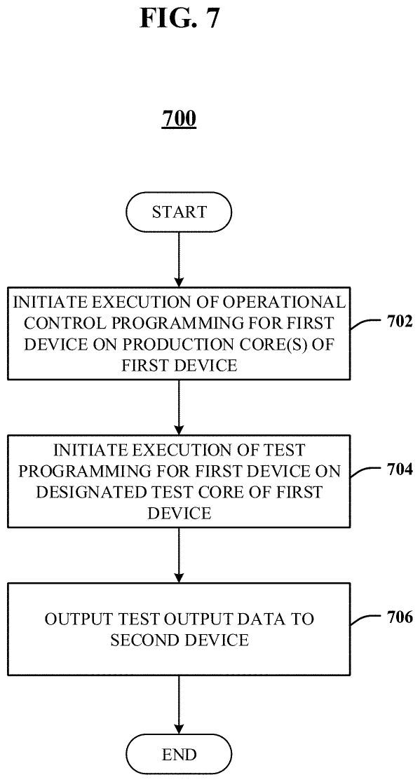

FIG. 7 is a block diagram of a process flow 700, which may be representative of operations executed in various implementations. As shown in process flow 700, execution of operational control programming for a first device on one or more production cores of the a first device may be initiated at 702. For example, boot loader 410 may initiate execution of operational control programming 412 on one or more production cores 403A of multi-core processor 402 of device 300. At 704, execution of test programming for the a first device may be initiated on a designated test core of the a first device. For example, boot loader 410 may initiate execution of test programming 414 on a designated test core 403B of multi-core processor 402 of device 300. At 706, test output data generated by the test programming may be output to a second device. For example, operational control programming 412 may identify test output data 518 as test output data that is to be offloaded from device 300.

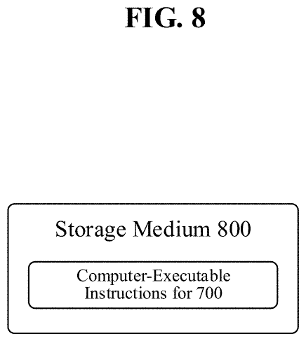

FIG. 8 illustrates an example storage medium 800. Storage medium 800 may be any non-transitory computer-readable storage medium or machine-readable storage medium, such as an optical, magnetic or semiconductor storage medium. In various implementations, storage medium 800 may be an article of manufacture. In some implementations, storage medium 800 may store computer-executable instructions, such as computer-executable instructions to implement process flow 700. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some implementations, the circuitry may be implemented in, or functions associated with the circuitry may be implemented by, one or more software or firmware modules. In some implementations, circuitry may include logic, at least partially operable in hardware.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described. The present invention is intended to be limited only by the following claims.

1. A first device, comprising:
a multi-core processor;
a memory storing instructions executable by the multi-core processor to:
initiate execution of operational control programming for the first device on one or more cores among a plurality of cores of the multi-core processor;
initiate execution of test programming for the first device on a designated test core among the plurality of cores of the multi-core processor, wherein the designated test core is not permitted as one of the one or more operational control cores, wherein the test programming generates test output data; and
output the test output data to a second device.

2. The first device of claim 1, comprising a memory protection unit to isolate a memory space of the operational control programming from a memory space of the test programming.

3. The first device of claim 1, wherein the operational control programming includes a first instance of an operating system (OS) running on the one or more cores, wherein the test programming includes a second instance of the OS running on the designated test core.

4. The first device of claim 1, wherein the operational control programming copies test input data to a memory space of the test programming to provide the test programming with access to the test input data.

5. The first device of claim 1, wherein the operational control programming triggers a data offload mechanism in response to a determination that the test output data is ready for offloading from the first device.

6. The first device of claim 1, wherein the test programming partitions the test output data into a plurality of data blocks and appends headers to the plurality of data blocks.

7. The first device of claim 1, wherein the memory stores instructions executable by the multi-core processor to send the test output data to the second device via a vehicle network of a vehicle including the first device.

8. The first device of claim 1, wherein the memory stores instructions executable by the multi-core processor to send the test output data over a vehicle bus to the second device.

9. The first device of claim 8, wherein the second device is a gateway module.

10. The first device of claim 1, wherein the operational control programming monitors a network connection for a disable signal from a testing back end.

11. The first device of claim 10, wherein the operational control programming disables the designated test core in response to detecting the disable signal.

12. A method, comprising:
initiating execution of operational control programming for a first device on one or more cores among a plurality of cores of a multi-core processor of the first device;
initiating execution of test programming for the first device on a designated test core among the plurality of cores of the multi-core processor, wherein the designated test core is not permitted as one of the one or more operational control cores, wherein the test programming generates test output data; and
outputting the test output data from the first device to a second device.

13. The method of claim 12, wherein the first device includes a memory protection unit to isolate a memory space of the operational control programming from a memory space of the test programming.

14. The method of claim 12, wherein the operational control programming includes a first instance of an operating system (OS) running on the one or more cores, wherein the test programming includes a second instance of the OS running on the designated test core.

15. The method of claim 12, wherein the operational control programming copies test input data to a memory space of the test programming to provide the test programming with access to the test input data.

16. The method of claim 12, wherein the operational control programming triggers a data offload mechanism in response to a determination that the test output data is ready for offloading from the first device.

17. The method of claim 12, wherein the test programming partitions the test output data into a plurality of data blocks and appends headers to the plurality of data blocks.

18. The method of claim 11, comprising sending the test output data to the second device via a vehicle network of a vehicle including the first device.

19. The method of claim 11, comprising sending the test output data over a vehicle bus to the second device.

20. The method of claim 19, wherein the operational control programming monitors a network connection for a disable signal from a testing back end and disables the designated test core in response to detecting the disable signal.
